(19) United States
(12) Patent Application Publication
(10) Pub. No.: US 2013/0326885 A1
(43) Pub. Date: Dec. 12, 2013

(54) HAND-HELD WORK TOOL

(71) Applicant: Andreas Stihl AG & Co. KG, Waiblingen (DE)

(72) Inventor: Klaus Kaupp, Stuttgart (DE)

(21) Appl. No.: 13/913,783

(22) Filed: Jun. 10, 2013

(30) Foreign Application Priority Data
Jun. 9, 2012 (DE) 10 2012 011 546.6

(51) Int. Cl. A01G 3/053

(52) U.S. Cl. CPC A01G 3/053
USPC 30/208

(57) ABSTRACT

A hand-held work tool has a drive motor and at least two cutting blades, at least one of which is driven back and forth by the drive motor. A first cover strip, which has at least keyhole-shaped openings, is arranged on a longitudinal side of one of the cutting blades. There are at least two fastening elements provided which project through the cutting blades and the first cover strip. Each opening has a slip-on portion and a fixing portion. The fixing portions, at least in part, engage behind the fastening portion of the associated fastening element with the first cover strip in the fixed state. The sides of the fixing portions of adjacent openings facing the slip-on portion are at a first spacing from one another. The sides of the fixing portions of adjacent fastening elements facing the fixing portions are at a second greater spacing from one another.

### CROSS-REFERENCE TO RELATED PATENT APPLICATIONS

This application is based upon and claims the benefit of priority from prior German Patent Application No. DE 10 2012 011 546.6, filed Jun. 9, 2012, the entire contents of which are incorporated herein by reference in their entirety.

### BACKGROUND

The application relates to a hand-held work tool comprising a drive motor, at least two cutting blades, wherein at least one of the cutting blades is driven back and forth by the drive motor, a first cover strip, wherein the first cover strip which is arranged on a longitudinal side of one of the cutting blades, wherein the first cover strip comprises at least one first opening, at least one second opening, and at least two fastening elements that project through the cutting blades and the first cover strip, wherein each first opening and each second opening comprises a slip-on portion comprising a first width that is at least as large as the width of a fastening portion of the fastening elements, and a fixing portion comprising a second width that is smaller than the width of the fastening portion of the fastening elements, wherein in a fixed state, the fixing portions engage, at least in part, behind the fastening portions of the fastening elements projecting through the first cover strip, a first length and a second length, wherein the first length is the length between adjacent the side of the fixing portion of the first opening facing the slip-on portion and the side of the fixing portion of the second opening facing the slip-on portion, wherein the second length is the length between the side of the fastening portion of the first fastening element facing the fixing portion of the first opening and the side of the fastening portion of the second fastening element facing the fixing portion of the second opening when the cover strip is in a non-fixed state, and wherein the first length is smaller than the second length.

In another embodiment, the hand-held work tool comprises a drive motor and having at least two cutting blades, wherein at least one of the cutting blades is driven back and forth by the drive motor, having a first cover strip which is arranged on a longitudinal side of one of the cutting blades, and which has at least one first keyhole-shaped opening and one second keyhole-shaped opening, and having at least two fastening elements which project through the cutting blades and the first cover strip, wherein each keyhole-shaped opening has a slip-on portion with a first width which is at least as large as the width of a fastening portion of the fastening element arranged on the first cover strip, and wherein each keyhole-shaped opening has a fixing portion with a second width which is smaller than the width of the fastening portion of the fastening element, wherein the fixing portions engage, at least in part, behind the fastening portion of the fastening element projecting through the fixing portion with the first cover strip in the fixed state, wherein the side of the fixing portion of the first opening facing the slip-on portion is at a first spacing from the side of the fixing portion of the second opening facing the slip-on portion, wherein the side of the fastening portion of the first fastening element facing the fixing portion with the cover strip in the non-fixed state is at a spacing, which is greater than the first spacing, from the side of the fastening portion of the second fastening element facing the fixing portion.

DE 198 29 132 A1 makes known a hand-held work tool, namely a hedge trimmer wherein a cover strip with keyhole-shaped openings is arranged on the cutting blades. The cutting blades and the cover strip are each penetrated by fastening elements. The cover strip is slipped onto the fastening elements in the region of certain slip-on portions and is then displaced in the longitudinal direction of the cutting blades until the fastening elements are arranged in the region of certain fixing portions. But because all keyhole-shaped openings are dimensionally the same, all the keyhole-shaped openings have to be slipped on at the same time and the fixing portions moved into engagement at the same time. This is difficult and often frustrating due to the long length of the cover strip.

### SUMMARY OF PREFERRED EMBODIMENTS

It is therefore one object underlying the invention to create a hand-held work tool of the generic type, wherein the cutting blades are able to be mounted in a simple manner.

In a preferred embodiment, this object is achieved by a hand-held work tool having a drive motor and having at least two cutting blades, wherein at least one of the cutting blades is driven back and forth by the drive motor, having a first cover strip which is arranged on a longitudinal side of one of the cutting blades, and which has at least one first keyhole-shaped opening and one second keyhole-shaped opening, and having at least two fastening elements which project through the cutting blades and the first cover strip, wherein each keyhole-shaped opening has a slip-on portion with a first width which is at least as large as the width of a fastening portion of the fastening element arranged on the first cover strip, and wherein each keyhole-shaped opening has a fixing portion with a second width which is smaller than the width of the fastening portion of the fastening element, wherein the fixing portions engage, at least in part, behind the fastening portion of the fastening element projecting through the fixing portion with the first cover strip in the fixed state, wherein the side of the fixing portion of the first opening facing the slip-on portion is at a first spacing from the side of the fixing portion of the second opening facing the slip-on portion, wherein the side of the fastening portion of the first fastening element facing the fixing portion with the cover strip in the non-fixed state is at a spacing, which is greater than the first spacing, from the side of the fastening portion of the second fastening element facing the fixing portion.

In another embodiment, it is provided that the sides of the fixing portions of a keyhole-shaped opening facing the slip-on portion of a keyhole-shaped opening and the sides of certain associated fastening elements facing the fixing portion have different spacings such that the spacings between the fastening elements are greater than the spacings between the fixing portions. In such a configuration, one fastening element engages at a time such that first of for example two fastening elements engages behind its associated fixing portion first, and then upon further displacement of the cover strip, the second of the two fastening elements engages its associated fixing portion. As a result, the operator is able to easily fix the cover strip successively at each individual openings, resulting in simplified handling. In such an embodiment, the fixing portion first engages the fastening element behind the fastening element, and the spacing of the fastening elements and of the fixing portions is decisive. The mounting of a plurality of fastening elements, as in the case of conventional cutting blades which are connected together by means of screws, is dispensed with as a result of the development of the cover strip. The width of the openings, in this case, is measured in the plane of the cutting blades at right angles with respect to the direction of movement of the at least one driven cutting blade and the longitudinal direction is measured in the direction of movement.

In a further embodiment, the first cover strip has more than two openings. By providing a larger number of openings, a more secure fixing of the cover strip may be achieved over its entire length. Advantageously, the spacing between adjacent openings remains constant as does the spacing between adjacent fastening elements, wherein the spacing between openings and the spacing between fastening elements constitute different lengths. As a result, the longitudinal displacement required to engage the next fixing portion behind the next fastening element remains approximately constant. Moreover, the path along which the cover strip has to be moved further until the next fastening element is engaged behind by the fixing portion of the associated opening, is constant. This means that mounting is simplified. In yet another embodiment, each keyhole-shaped opening has the same overall longitudinal length and has a fixing portion and a slip-on portion. Advantageously, the longitudinal length of the slip-on portion of the first keyhole-shaped opening is greater than the length of the slip-on portion of the second keyhole-shaped opening. As a corollary, the longitudinal length of the fixing portion of the first keyhole-shaped opening is smaller than the length of the fixing portion of the second keyhole-shaped opening. As a result, the fixing portion of each keyhole-shaped opening do not engage the fastening elements at the same time, but rather engage them sequentially as the cover strip is displaced in the longitudinal direction. Optionally, more than two keyhole-shaped openings may be provided in the same configuration detailed in this embodiment, wherein the longitudinal lengths of the slip-on portions become progressively smaller as the longitudinal lengths of the fixing portions become progressively larger.

In yet a further embodiment, the length of the fixing portion of the first opening from the slip-on portion as far as up to the position in which the fastening element is situated when the first cover strip is fixed, has a first length in the longitudinal direction of the cutting blades. The fixing portion of the second opening, from the slip-on portion as far as up to the position in which the fastening element is situated when the first cover strip is fixed, has a second length which is greater than the first length. The fixing portions do not engage behind the heads of the fastening elements at the same time on account of the different length between the fixing portions of the keyhole-shaped openings, but rather one after the other.

In still another embodiment, the cutting blades have a first end which faces a housing of the work tool and a second end which faces away from the housing of the work tool. In an advantageous manner, the cover strip is fixed first on its end facing away from the housing of the work tool. For this purpose, it may be provided, in particular, that the length of the fixing portions of the keyhole-shaped openings is greatest at the end of the cover strip facing away from the housing and smallest at the end of the cover strip facing the housing, wherein the length of each fixing portion sequentially closer to the housing is sequentially smaller than the length of the previous fixing portion. As a result, the operator, beginning at the free end of the cutting blades, is able to fix the cover strip on one fastening element after the other. In an advantageous manner, the difference between the lengths of the fixing portions of adjacent keyhole-shaped openings is the same for all adjacent openings. As a result, the path along which the cover strip has to be displaced in the longitudinal direction for fixing the associated fastening element is the same for each fastening element. The overall length of the slip-on portion and the fixing portion, in this case, is advantageously approximately the same for all keyhole-shaped openings. As a result, the fastening elements are arranged in each case at the end of the associated fixing portions in the fixed position of the cover strip.

In still a further embodiment, the first cover strip is secured in its position by means of a securing means as would be known by one of ordinary skill in the art. The securing means prevents the cover strip from being able to be moved unintentionally in the longitudinal direction of the cutting blades during operation. This also prevents one or several fastening elements from being able to pass into the region of the associated slip-on portions and prevents the cover strip from detaching. Optionally, the securing means is a latching element which is fixed in relation to a housing of the work tool and, in the fixed position of the cover strip, is latched in a securing opening in the first cover strip. Optionally, said latching element is a leaf spring. In an advantageous manner, the leaf spring has an edge which latches on the securing opening. Optionally, as a further example, it can also be provided that the securing means is a locking screw which is screwed into a component which is fixedly connected to the housing of the work tool and which fixes the first cover strip in relation to the housing. In an advantageous manner, the locking screw fixes the cover strip in a friction-locking and positive-locking manner by clamping the cover strip against the cutting blades. As a result, to mount the cover strip the cover strip has only to be slipped on, displaced in the longitudinal direction and then a single screw screwed in such that the cover strip is mounted in a simple and rapid manner and consequently the blades are changed in a simple and rapid manner.

In other embodiments, the securing means might include one or more of the preceding or the following: a bar, a bolt, a brad, a catch, a clamp, a coupling, a dowel, a fastener, a lag, a latch, a lock, a nail, a nut, a peg, a pin, a pipe, a rivet, a rod, a screw, a skewer, a sliding bar, a spike, a stake, a staple, a stud, a glue, a tape, an adhesive, a rope, a cord, a wire, an anchor, and/or a Velcro.

In still yet another embodiment, the work tool has a second cover strip which is arranged on the side of the cutting blades located opposite the first cover strip and which is fixed on a housing part of the work tool. The securing means, in this case, is fixed in particular on the second cover strip. The arrangement of a first and a second cover strip produces a high level of stability for the tool. Approximately no relative movement takes place on the locating faces of the fastening elements on the cover strips so that a sturdy design is produced.

In a further embodiment, the work tool has a gearing unit, by means of which at least one of the cutting blades is driven. A rapid and simple mounting of the cutting blades can be achieved when the at least one cutting blade driven back and forth has an opening by way of which it is slipped onto a coupling element which is in operative connection with the gearing unit. As a result, the measuring blades do not have to be screw-connected to the gearing unit or to components in operative connection therewith, but are simply slipped on in a direction at right angles with respect to the plane of the cutting blades. The coupling element is advantageously a mounting bolt. The securing of the at least one driven cutting blade to the coupling element is effected in an advantageous manner by means of the cover strip, which prevents the cutting blade being removed in the axial direction of the coupling element, that is perpendicular with respect to the plane of the cutting blades.

Further objects, features, and advantages of the present application will become apparent form the detailed description of preferred embodiments which is set forth below, when considered together with the figures of drawing.

### BRIEF DESCRIPTION OF THE DRAWINGS

Exemplary embodiments are explained below by way of the drawings, in which:

FIG. 1 shows a schematic, perspective representation of a hedge trimmer,

FIG. 2 shows a view from above of the cutting blades and the cutting blade housing of the hedge trimmer from FIG. 1,

FIG. 3 shows a perspective representation of the hedge trimmer in the region of the cutting blade housing with the cutting blade housing split,

FIG. 4 and FIG. 5 show perspective exploded representations of the cutting blade housing and the cutting blades of the hedge trimmer,

FIG. 6 shows an enlarged cutout from a view from below of the cutting blades and the cover strip,

FIGS. 7 to 11 show a view from below of the cutting blades in different positions of the cover strip,

FIG. 12 shows a longitudinal section through the gearing unit and the cutting blades,

FIG. 13 shows a perspective exploded representation of the cutting blades and cover strips,

FIG. 14 shows an enlarged representation of a detail of the hedge trimmer from FIG. 12 in the region of the attachment of the cutting blades,

FIGS. 15 and 16 show sectional representations through exemplary embodiments of the hedge trimmer in the region of the attachment of the cutting blades.

### DETAILED DESCRIPTION OF PREFERRED EMBODIMENTS

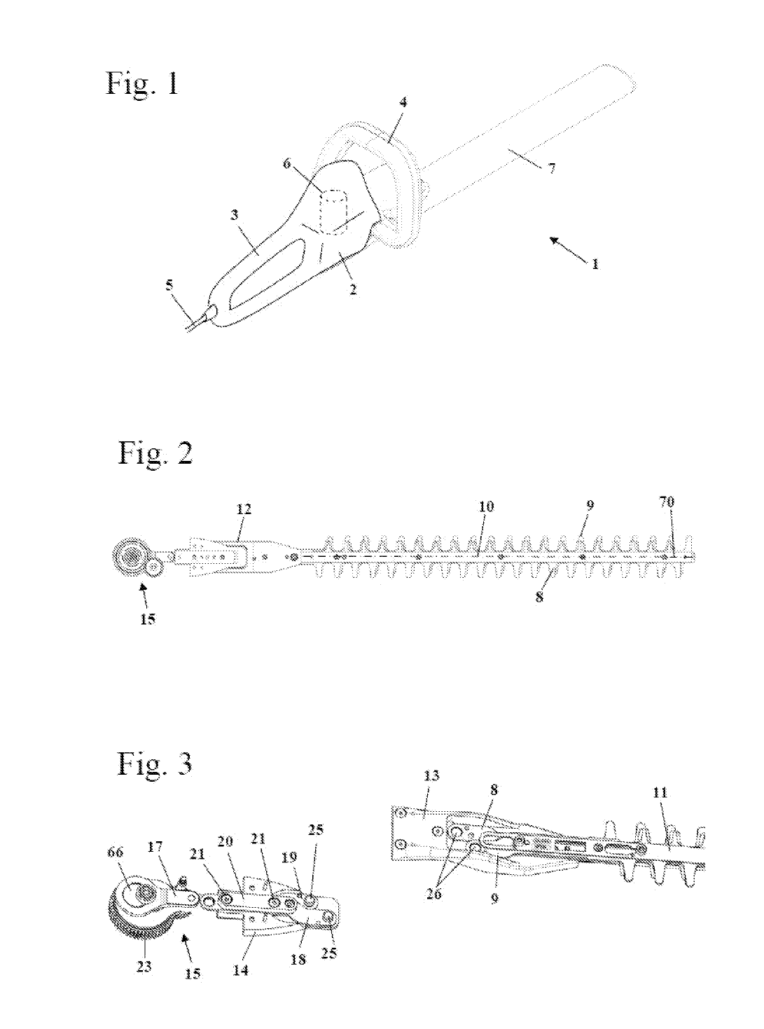

A hedge trimmer 1 is shown in FIG. 1 as an exemplary embodiment for a hand-held work tool. The hedge trimmer 1 has a housing 2, on which a rear handle 3 and a bow-type handle 4 are secured. The bow-type handle 4 is in two parts. A drive motor 6, which is realized as an electric motor in the exemplary embodiment and is supplied with power by means of a connection cable 5, is arranged in the housing 2. The drive motor 6, however, can also be supplied with power from a battery, in particular a rechargeable battery. The drive motor 6 can also be an internal combustion engine, in, for example, an oil-in gasoline lubricated internal combustion engine. In one embodiment, the drive motor 6 cannot be put into operation until the two portions of the bow-type handle 4 are pressed together by the operator. This ensures that one hand of the operator is arranged on the bow-type handle 4 when it is operating. The drive motor 6 drives the cutting blades 8 and 9 shown in FIG. 2 back and forth in the longitudinal direction 70 of the cutting blades 8 and 9. In FIG. 1, the cutting blades 8 and 9 are covered by a guard 7 which is arranged on the cutting blades 8 and 9 for transport and for preserving the hedge trimmer 1.

As shown in FIG. 2, the cutting blades 8 and 9 are driven by means of a gearing unit 15. The cutting blades 8 and 9 project by way of one end into a cutting blade housing 12 in which they are connected to the gearing unit 15. A second cover strip 10 is arranged on the upper cutting blade 8. A first cover strip arranged on the underside of the cutting blades cannot be seen in FIG. 2.

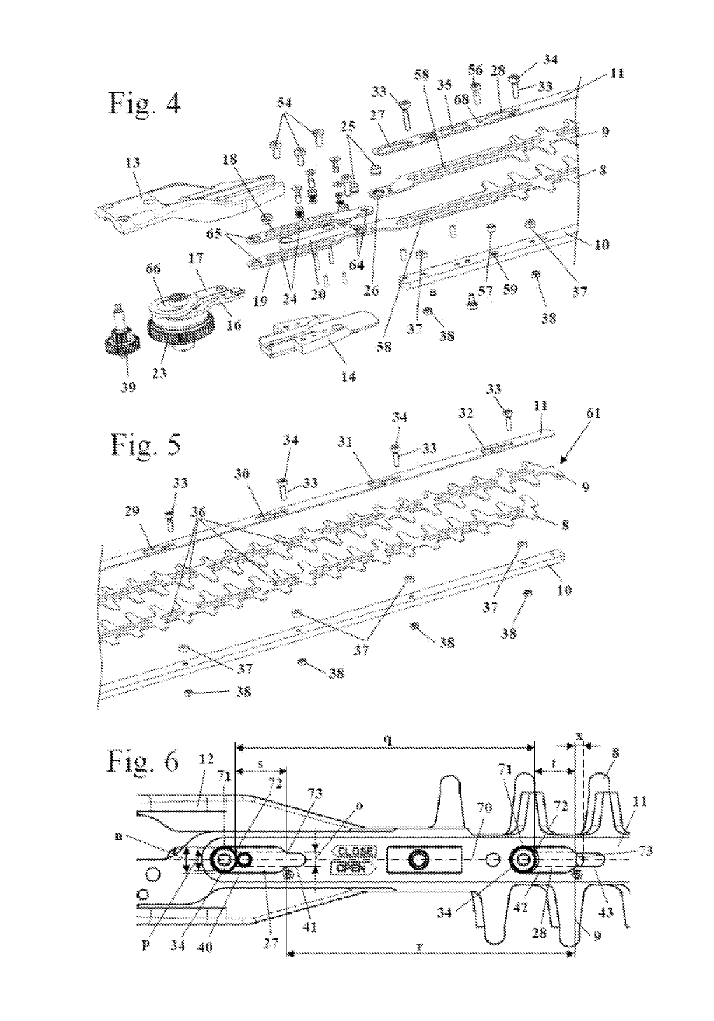

As shown in FIG. 3 and FIG. 4, the cutting blade housing 12 has a first housing part 13, through which the cutting blades 8 and 9 are inserted. The first housing part 13 is closed by a second housing part 14 on its upper side. The upper side is the side that is on the top when the hedge trimmer 1 is placed down on a level surface in the effective direction of gravity and the underside is the side that lies underneath facing the surface in said position. As shown in FIG. 3, a guide piece 20, which is fixed by way of screws not shown in FIG. 3 and by way of guide elements 21, is secured on the second housing part 14. Two guide elements 21 which are sleeve-shaped are provided in the exemplary embodiment. The guide elements 21 project into guide grooves (FIG. 4) of two intermediate parts 18 and 19. As a result, the intermediate parts 18 and 19 are guided on the second housing part 14 in the longitudinal direction of the cutting blades 8 and 9. The guide grooves 24 are realized as elongated holes in the exemplary embodiment. At their ends facing the cutting blades 8 and 9, the intermediate parts 18 and 19 have the openings 64, shown in FIG. 4, by means of which they are able to be connected to the cutting blades 8 and 9. The intermediate parts 18 and 19 are bent off at the side so that the openings 64 lie side by side in operation. In a corresponding manner, the cutting blades 8 and 9 are also bent off at the side. At their end facing the gearing unit 15, the intermediate parts 18 and 19 have openings 65 which are arranged one on top of the other and engage in the journals (not shown in FIG. 3) of connecting rods 16 and 17 of the gearing unit 15. The connecting rods 16 and 17 are driven back and forth by means of an eccentric 66 shown in FIGS. 3 and 4. The eccentric 66 is non-rotatably connected to a toothed wheel 23 which is rotatingly driven by a driving pinion 22 (FIG. 12) by means of an intermediate gear 39. The driving pinion 22 is advantageously arranged directly on the driven shaft of the drive motor 6. The arrangement of the drive motor 6 on the gearing unit 15 is shown schematically in FIG. 12.

As shown in FIG. 3, mounting bolts 25 are arranged on the ends of the intermediate parts 18 and 19 which are located facing the cutting blades 8 and 9. The cutting blades 8 and 9 are simply slipped onto the mounting bolts 25 by way of their mounting openings 26. It is possible to slip the cutting blades 8 and 9 onto the mounting bolts 25 simply and without any tools.

The second housing part 14 is secured on the housing 2 of the hedge trimmer 1, in particular on a gearing housing of the hedge trimmer 1, by means of the screws 54 shown in FIG. 4. The first housing part 13 is screw-connected on the second housing part 14. FIG. 4 also shows the mounting bolt 25 and the associated mounting opening 26 of the cutting blade 9. The second cover strip 10, the upper cover strip, shown in FIG. 4 is fixed on the first housing part 13 of the cutting blade housing 12. The second cover strip 10, in this case, projects into a groove in the second housing part 14. As a result, the second cover strip 10 is fixed in a sturdy manner on the cutting blade housing 12.

The first cover strip 11 is arranged on the bottom longitudinal side of the cutting blade 9 and the second cover strip 10 is arranged on the opposite longitudinal side of the cutting blade 8 which points upward when the hedge trimmer is put down. Fastening elements, which are realized in the exemplified embodiment as screws 33, are provided for fastening the cutting blades 8 and 9 and the cover strips 10 and 11 to one another. Fastening elements which are developed in a different manner, for example bolts or the like, can also be provided in place of the screws 33. The screws 33, in each case, have a head 34 which has a widened diameter and which is arranged adjacent to the first cover strip 11. The first cover strip 11 has openings 27, 28, 29, 30, 31, 32 which are each realized in a keyhole-shaped manner. A screw 33 projects in each case through the keyhole-shaped openings 27 to 32. On the side adjacent to the second cover strip 10, the screws 33 are screwed into the cover strip 10 and secured by means of nuts 38. The screws 33 project in each case through a guide sleeve 37 which is arranged between the cover strips 10 and 11 and penetrates the elongated holes 58 and 36 of the cutting blades 8 and 9. The guide sleeve 37 serves for guiding the cutting blades 8 and 9. As shown in FIG. 4, the first cover strip 11 has a rectangular securing opening 35 between the first opening 27 and the second opening 28. In the case of the exemplary embodiment shown in FIG. 4, the securing opening 35 does not have a function. A hole 68, through which a screw 56 projects, is arranged between the securing opening 35 and the second opening 28. The screw 56 is screwed into a threaded bore 59 of the second cover strip 10.

FIGS. 6 to 11 show the development of the keyhole-shaped openings 27 to 32 in detail. FIG. 6 shows an enlarged representation of the two openings 27 and 28 which face the first end 60 (FIG. 7). The first opening 27, which is arranged adjacent to the cutting blade housing 12 and to the first end 60 of the cutting blades 8, 9, has a slip-on portion 40, the width n of which is approximately as great as or somewhat greater than the width p of the head 34 of the screw 33. A fixing portion 41 connects to the slip-on portion 40 in the direction of the second end 61 (FIG. 7). The fixing portion 41 has a width o which is measured at right angles with respect to the longitudinal direction 70 and is smaller than the width p of the head 34, but is somewhat greater than the nominal diameter of the screw 33.

The portion of the head 34, which is wider than the fixing portion 41 and which is engaged behind by the portions of the cover strip 11 arranged adjacent to the fixing portion 41 when the cover strip 11 is completely fixed, forms a fastening portion 71. The opening 28 adjacent in the direction of the second end 60 has a slip-on portion 42 and a fixing portion 43. The side 72, facing the fixing portion 41, of the fastening portion 71 of the head 34 arranged in the opening 27 is at a spacing q from the side 72, facing the fixing portion 43, of the fastening portion 71 of the head 34 arranged in the opening 28 when the cover strip 11 is not fixed. Each of the fixing portions 41 and 43 have a side 73 which faces the slip-on portion 40, 42 of the respective opening 27, 28. The sides 73 of the adjacent fixing portions 41 and 43 are at a spacing r from one another which is smaller than the spacing q of the fastening portions 71. The spacing r is smaller than the spacing q by a difference x. If the cover strip 11 is moved in the direction of the first end 60, the fastening portion 71 engages with the fixing portion in the second opening 28 once the cover strip 11 has covered a path which corresponds to a spacing t between the side 72 of the fastening element 71 and the side 73 of the fixing portion 43. The fastening portion 71 in the first opening 27 does not engage with the fixing portion 41 until the cover strip 11 has covered a path which corresponds to a spacing s between the side 72 of the fastening element 71 and the side 73 of the fixing portion 41. In this case, the spacing s is greater than the spacing t by the difference x.

As shown in FIG. 7, all keyhole-shaped openings 27 to 32 have the same overall length a measured in the longitudinal direction 70 of the cutting blades 8, 9. The slip-on portion 40 has a length b measured in the longitudinal direction 70 and the fixing portion 41 has a length c. The length c of the fixing portion 41 is measured from the slip-on portion 40 as far as up to the region in which the screw 33 is situated with the first cover strip 11 completely fixed. In the exemplary embodiment, with the cover strip 11 fixed, the screw 33 is arranged at the end of the keyhole-shaped opening such that the length c of the fixing portion 41 is measured as far as up to the end of the opening 27. The adjacent, second keyhole-shaped opening 28 has a slip-on portion 42 with a length d, which is somewhat smaller than the length b of the slip-on portion 40, and a fixing portion connecting thereto, the length of which e is somewhat greater than the length c of the fixing portion 41. The third keyhole-shaped opening 29 connecting to the second opening 28 in the direction of the second end 61 has a slip-on portion 44 with a length f, which is somewhat smaller than the length d of the slip-on portion 42, and a fixing portion 45 connecting thereto, the length g of which is somewhat greater than the length e of the fixing portion 43. The fourth opening 30 arranged adjacent to the third opening 29 has a slip-on portion 46 with a length h which is somewhat smaller than the length f of the slip-on portion 44, as well as a fixing portion 47 connecting thereto with a length i which is somewhat greater than the length g of the fixing portion 45. The fifth keyhole-shaped opening 31 arranged adjacent to the keyhole-shaped opening 30 has a slip-on portion 48, the length j of which is somewhat smaller than the length h of the slip-on portion 46, as well as a fixing portion 49 connecting thereto, the length k of which is somewhat greater than the length e. The sixth keyhole-shaped opening 32 which is arranged adjacent to the keyhole-shaped opening 31 and is arranged between the opening 31 and the end 61 of the cutting blades 8, 9, has a slip-on portion 50, the length l of which is somewhat smaller than the length j of the slip-on portion 48. The length l corresponds advantageously approximately to the diameter of the head 34 of the screw 33. A fixing portion 51, the length m of which is somewhat greater than the length k of the fixing portion 49, connects to the slip-on portion 50.

As the spacing from the first end 60 of the cutting blades 8, 9 increases, the length of the slip-on portion measured in the longitudinal direction 70 decreases accordingly. The length of the adjacent fixing portion is increased to the same extent. In an advantageous manner, the difference x between the spacings q and r of adjacent fastening elements 71 and associated adjacent fixing portions 41, 43, 45, 47, 49, 51, in this case, is the same for all fastening elements 71 and openings 27, 28, 29, 30, 31, 32.

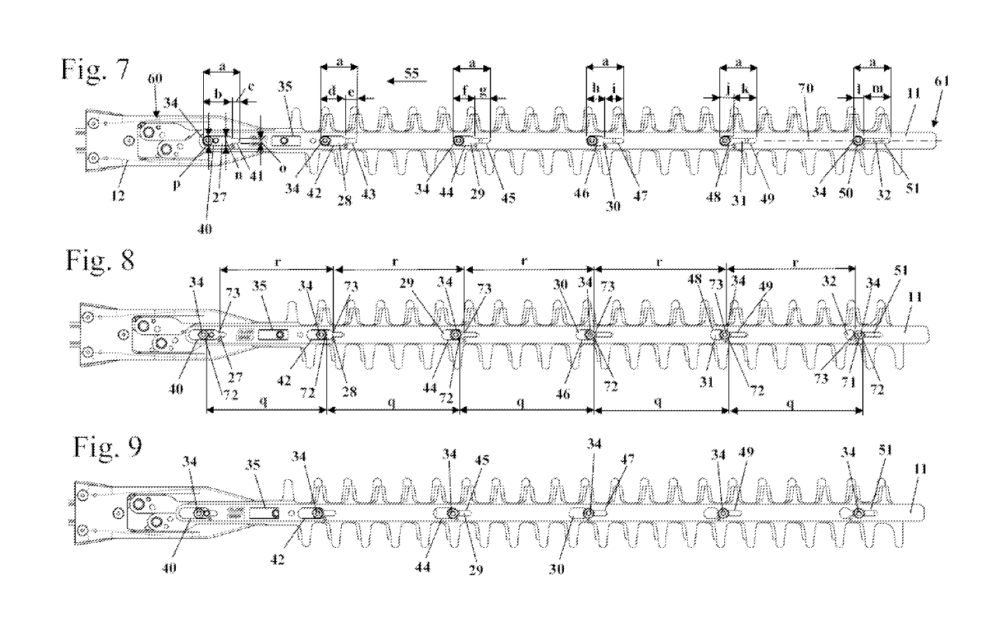

When mounting the cutting blades 8, 9, they are first of all placed onto the mounting bolts 25. In addition, the cutting blades are slipped by way of their elongated holes 58 and 36 onto the screws 33, which are already screwed into the second cover strip 10. The elongated holes 58 and 36, in this case, are realized sufficiently wide that the heads 34 of the screws 33 are able to be pushed through the elongated holes 36, 58. The first cover strip 11 is then slipped onto the screws 33 with the slip-on portions 40, 42, 44, 46, 48, 50 in the position shown in FIG. 7 until the heads 34 of the screws 33 project through the first cover strip 11. The cover strip 11 is then moved in the direction of the arrow 55 shown in FIG. 7 in the direction of the cutting blade housing 12. FIGS. 8 to 11 show the cover strip 11 when displaced in the direction of the arrow 55. In the position shown in FIG. 8, the screw 33 in the sixth opening 32 is already arranged in the fixing portion 51. The sides of the cover strip 11 defining the fixing portion 51 engage behind the fastening portion 71 of the head 34 and thus secure the cover strip 11 and the cutting blades 8 and 9 on the second cover strip 10 in the longitudinal direction of the screw 33. The screw 33 in the opening 31 is situated at the transition between the slip-on portion 48 and the fixing portion 49 and is also already engaged behind in part by the first cover strip 11. The screw 33 in the fourth opening 30 is still situated in the slip-on portion 46. The screws 33 in the openings 27, 28 and 29 are also arranged in each case in associated slip-on portions 40, 42, 44. In this case, the heads 34 of the screws 33 are shown in each case in FIGS. 6 to 11.

As shown in FIG. 8, the sides 72 of the fastening portions 71 which face the associated fixing portions 41, 43, 45, 47, 49, 51, in the non-fixed state of the cover strip 11 shown in FIG. 7, are in each case at a spacing q from one another. The sides 73 of adjacent fixing portions 41, 43, 45, 47, 49, 61 facing the slip-on portions 40, 42, 44, 46, 48, 50 are at a spacing r from one another. In this case, the difference x between the spacings q and r is the same for all openings 27, 28, 29, 30, 31, 32. The spacings q and r can be different for different openings 27, 28, 29, 30, 31, 32 and different fastening portions 71. In each case, the region of the fastening element 71 and fixing portion 41, 43, 45, 47, 49, 51 which brings about fixing in the longitudinal direction of the screw 33 first of all is definitive to the spacings q and r.

When the first cover strip 11 is displaced further in the direction of the arrow 55 into the position shown in FIG. 9, the screw 33 in the opening 30 also moves into the fixing portion 47. The screw 33 in the opening 29 is arranged at the transition between the slip-on portion 44 and the fixing portion 45 and is engaged behind in part by the cover strip 11. The screws 33 in the fixing portions 49 and 51 continue to be moved in the fixing portions.

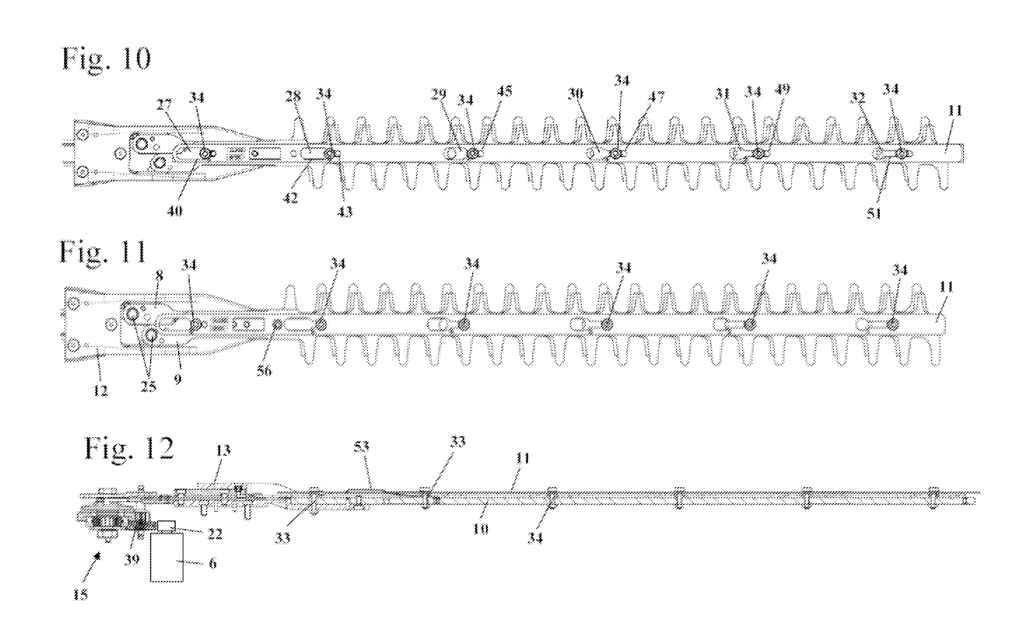

In the position of the first cover strip 11 shown in FIG. 10, only the screw 33 in the first opening 27 is still arranged completely in the slip-on portion 40. All further heads 34 of the screws 33 in the openings 28 to 32 are engaged behind by the cover strip 11.

FIG. 11 shows the arrangement of the cover strip 11 in the completely mounted position. In said position all the screws 33 are arranged in the associated fixing portions and the cover strip 11 engages behind the heads 34 of the screws 33. In said position, the cutting blades 8 and 9 are fixed on the second cover strip 10 in the longitudinal direction of the screws 33. As a result, the cutting blades 8 and 9 are no longer able to slip off the mounting bolt 25. The locking screw 56, which projects through the first cover strip 11 and which is screwed into the second cover strip 10, is provided to secure the position of the first cover strip 11. As a result, the first cover strip 11 is no longer able to be displaced in the longitudinal direction 70.

As shown in FIG. 12, a stop spring 53, which is fixed on the second cover strip 10 by means of one of the screws 33, can also be provided for securing the position of the first cover strip 11. The stop spring 53 can also be fixed on the first cover strip 11 by means of an additional fastening means.

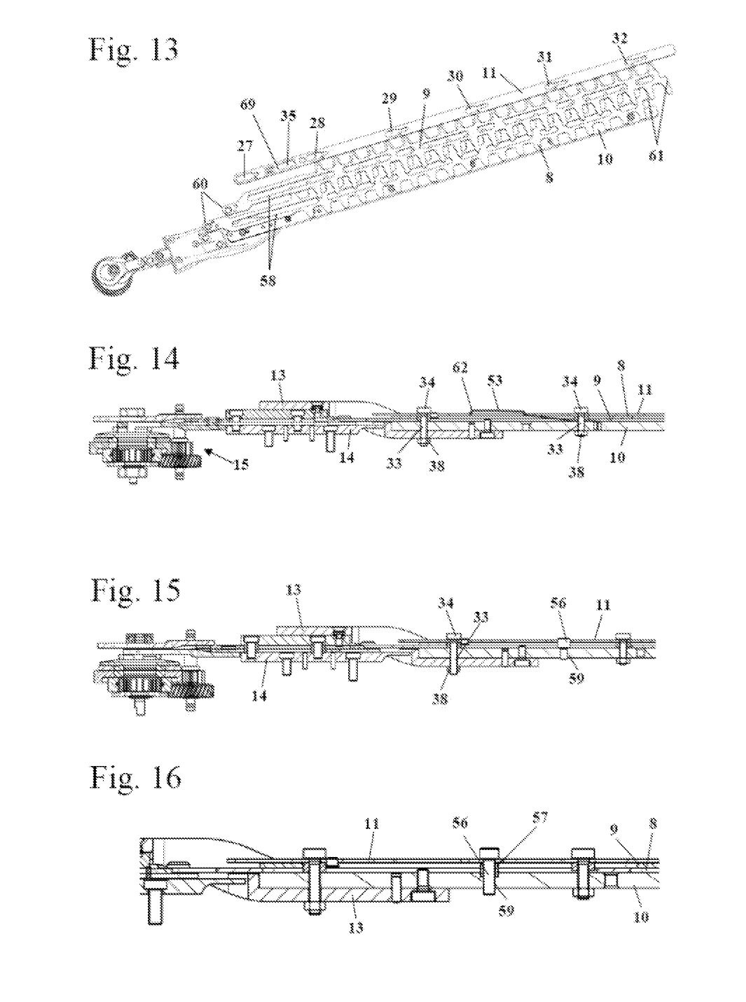

As shown in FIG. 14, the stop spring 53 has an edge 62, which faces the first end 60 of the cutting blades 8, 9 (FIG. 13) and engages behind an edge 69 of the securing opening 35 (FIG. 13) and latches on said edge. Unintentional displacement of the first cover strip 11 can also be prevented by the stop spring 53.

FIG. 15 shows the arrangement of the locking screw 56 in detail. The locking screw 56 has a widened head which projects through the hole 68 in the first cover strip 11 shown in FIG. 5. The diameter of the hole 68 is advantageously only slightly greater than the diameter of the head of the screw 56 such that the cover strip 11 is secured in a positive locking manner by the head of the screw 56. FIG. 16 shows a further design variant of the securing of the cover strip 11. In this case, a locking sleeve 57 is provided on the screw 56, the height of which protruding beyond the second cover strip 10 corresponds at least approximately to the common thickness of the cutting blades 8 and 9. The diameter of the head of the locking screw 56 is somewhat greater than the diameter of the hole 68 (FIG. 5) in the cover strip 11. The diameter of the hole 68 is approximately as large or somewhat greater than the nominal diameter of the locking screw 56. The locking screw 56 is screwed into the cover strip 11. The head of the screw 56 is arranged on the outside of the first cover strip 11 and secures the cover strip 11 in a friction locking and positive locking manner.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A hand-held work tool comprising:
(a) a drive motor;
(b) at least two cutting blades, wherein at least one of the cutting blades is driven back and forth by the drive motor;
(c) a first cover strip, wherein the first cover strip which is arranged on a longitudinal side of one of the cutting blades, wherein the first cover strip comprises (i) at least one first opening, (ii) at least one second opening, and (iii) at least two fastening elements that project through the cutting blades and the first cover strip,
wherein each first opening and each second opening comprises (i) a slip-on portion comprising a first width that is at least as large as the width of a fastening portion of the fastening elements, and (ii) a fixing portion comprising a second width that is smaller than the width of the fastening portion of the fastening elements,
wherein in a fixed state, the fixing portions engage, at least in part, behind the fastening portions of the fastening elements projecting through the first cover strip;
(d) a first length and a second length, wherein the first length is the length between adjacent (i) the side of the fixing portion of the first opening facing the slip-on portion and (ii) the side of the fixing portion of the second opening facing the slip-on portion,
wherein the second length is the length between (i) the side of the fastening portion of the first fastening element facing the fixing portion of the first opening and (ii) the side of the fastening portion of the second fastening element facing the fixing portion of the second opening when the cover strip is in a non-fixed state, and
wherein the first length is smaller than the second length.

2. The hand-held work tool according to claim 1, wherein the first cover strip comprises more than two openings.

3. The hand-held work tool according to claim 2, wherein the difference between the first length and the second length is approximately the same across all openings.

4. The hand-held work tool according to claim 2, wherein the cutting blades comprise a first end facing a housing of the work tool and a second end facing away from the housing of the work tool.

5. The hand-held work tool according to claim 4, wherein the length of the fixing portions of the openings increases sequentially from the first end to the second end.

6. The hand-held work tool according to claim 5, wherein the difference between the lengths of the fixing portions of adjacent openings is the same for all adjacent openings.

7. The hand-held work tool according to claim 1, wherein the combined length of the slip-on portion and the fixing portion is approximately the same for all openings.

8. The hand-held work tool according to claim 1, wherein the first cover strip is secured in its position by a securing element.

9. The hand-held work tool according to claim 8, wherein the securing element is a latching element which is fixed in relation to a housing of the work tool and which, in the fixed position of the first cover strip, is latched in a securing opening in the first cover strip.

10. The hand-held work tool according to claim 9, wherein the securing element is a locking screw which is screwed into a component which is fixedly connected to the housing of the work tool and which fixes the first cover strip in relation to the housing.

11. The hand-held work tool according to claim 8, wherein the work tool further comprises a second cover strip arranged on the side of the cutting blades located opposite of the first cover strip, and wherein the second cover strip is fixed on a housing part of the work tool.

12. The hand-held work tool according to claim 11, wherein the securing element is fixed on the second cover strip.

13. The hand-held work tool according to claim 1, wherein the work tool further comprises a gearing, wherein the gearing unit drives at least one of the cutting blades, wherein the at least one cutting blade driven comprises a mounting opening, wherein the mounting opening is slipped onto a coupling element which is in operative connection with the gearing unit.

14. The hand-held work tool according to claim 13, wherein the coupling element is a mounting bolt.

15. The hand-held work tool according to claim 13, wherein the first cover strip secures the at least one cutting blade on the coupling element.
